(19) United States
(12) Patent Application Publication
(10) Pub. No.: US 2024/0228342 A9
(43) Pub. Date: Jul. 11, 2024

(54) UREA TREATMENT APPARATUS AND UREA TREATMENT METHOD

(71) Applicant: ORGANO CORPORATION, Tokyo (JP)

(72) Inventors: Yui SHIOYA, Tokyo (JP); Kazushige TAKAHASHI, Tokyo (JP); Fumio SUDO, Tokyo (JP)

(73) Assignee: ORGANO CORPORATION, Tokyo (JP)

(21) Appl. No.: 18/277,244

(22) PCT Filed: Jan. 18, 2022
(86) PCT No.: PCT/JP2022/001562

§ 371 Date: Aug. 15, 2023

(30) Foreign Application Priority Data
Feb. 17, 2021 (JP) 2021-023654

(51) Int. Cl. C02F 1/76; C02F 1/42; C02F 1/44; C02F 1/70

(52) U.S. Cl. CPC C02F 1/76; C02F 1/42; C02F 1/441; C02F 1/70; C02F 2209/20; C02F 2209/44

(57) ABSTRACT

A urea treatment apparatus for treating urea in a water to be treated includes a first reaction tank in which urea in the water to be treated is treated; a first addition means connected to the first reaction tank or to a first piping connected to the first reaction tank and supplying the water to be treated to the first reaction tank, for adding a bromide salt and a chlorine-based oxidation agent to the water to be treated; a second reaction tank in which a residual urea in a first treated water treated by the first reaction tank is treated, a second addition means connected to the second reaction tank or to a second piping connected to the second reaction tank and supplying the first treated water to the second reaction tank, for adding a chlorine-based oxidation agent or a mineral acid to the first treated water.

### TECHNICAL FIELD

This application is based on Japanese Application 2021-23654, filed Feb. 17, 2021, and claims priority based on that application. This application is incorporated by reference in its entirety into this application.

This invention relates to a urea treatment apparatus and a urea treatment method, especially to a urea treatment apparatus and a urea treatment method in a pure water production process.

### BACKGROUND ARTS

A pure water production apparatus used to produce pure water from raw water such as a tap water, a groundwater, and an industrial water, for example, consists of a combination of a reverse osmosis membrane apparatus, an ion exchange apparatus, and an ultraviolet oxidation apparatus.

When urea is contained in the raw water, it is difficult to remove by any of the reverse osmosis membrane apparatus, the ion exchange apparatus, and the UV oxidation apparatus, and the residual urea in the produced pure water increases a total organic carbon (TOC) concentration of the pure water.

A process to remove urea from the raw water is necessary, in the case of producing particularly pure water, i.e. ultrapure water, for applications such as semiconductor manufacturing, as the upper limit for a TOC concentration in the resulting ultrapure water is strictly set.

JP H9-94585 discloses a method of decomposing and removing urea with hypobromite in a reaction tank by adding a chemical agent that produces hypobromite to raw water and supplying it to the reaction tank.

Since in general, urea decomposition reactions take a long time to react, it is necessary to ensure that the residence time in the reaction tank is long. In such a urea treatment method (treatment apparatus), if urea is not fully decomposed in the reaction tank and flows out to the rear stage of the reaction tank, even if additional chemicals that produce hypobromite are added to the raw water at that point, a time lag will occur before treated water with urea removed is obtained.

There is a problem that a treated water with an increased TOC value is supplied to the use point in the meantime.

It is therefore an object of the present invention to provide a urea treatment apparatus and a urea treatment method that can suppress the supply of treated water with an increased TOC value to a use point.

The invention comprises the following [1] to [10].

[1] A urea treatment apparatus for treating urea in a water to be treated, comprising:
a first reaction tank in which urea in the water to be treated is treated;
a first addition means connected to the first reaction tank or to a first piping connected to the first reaction tank and supplying the water to be treated to the first reaction tank, for adding a bromide salt and a chlorine-based oxidation agent to the water to be treated;
a second reaction tank in which a residual urea in a first treated water treated by the first reaction tank is treated
a second addition means connected to the second reaction tank or to a second piping connected to the second reaction tank and supplying the first treated water to the second reaction tank, for adding a chlorine-based oxidation agent or a mineral acid to the first treated water.
   [2] The urea treatment apparatus as described in [1] above, wherein a residence time of the first treated water in the second reaction tank is shorter than a residence time of the water to be treated in the first reaction tank.
   [3] The urea treatment apparatus as described in [1] or [2] above, comprising:
a measuring apparatus which is installed at the rear of the second reaction tank to measure a TOC or urea concentration in the second treated water treated in the second reaction tank; and
a means controlling an amount of addition from the first addition means and/or the second addition means according to the TOC or urea concentration in the second treated water.
   [4] The urea treatment apparatus as described in [1] to [3] above, comprising a means for adding a reducing agent, which is installed at the rear of the second reaction tank and reduces the oxidant component in the second treated water.
   [5] A pure water production system comprising the urea treatment apparatus as described in [1] to [4] above, an ion exchange apparatus which is installed at the rear of the urea treatment apparatus and supplied with a water treated by the urea treatment apparatus, and a reverse osmosis membrane apparatus which is installed at the rear of the ion exchange apparatus and supplied with a water treated by the ion exchange apparatus.
   [6] A urea treatment method for treating urea in a water to be treated, comprising:
a first treatment process in which a bromide salt and a chlorine-based oxidation agent are added to the water to be treated as a urea decomposition agent, and
a second treatment process in which at least one of a chlorine-based oxidation agent or a mineral acid is added to the first treated water obtained in the first treatment process to treat a residual urea in the first treated water.
   [7] The urea treatment method as described in [6] above, wherein a treatment time of the second treatment process is shorter than a treatment time of the first treatment process.
   [8] The urea treatment method as described in [6] or [7] above, comprising:
a measurement process for measuring a TOC or urea concentration in the second treated water obtained in the second treatment process; and
an addition amount control process for controlling an amount of the urea decomposition agent added in the first treatment process and/or the second treatment process according to the TOC or urea concentration in the second treated water.
   [9] The urea treatment method as described in [6] to [8] above, comprising a reduction process to reduce an oxidant component in the second treated water.
   [10] A method for producing pure water, comprising the urea treatment method as described in [6] to [9], above, as a pre-treatment process.

The present invention provides a urea treatment apparatus and a urea treatment method that can suppress the supply of treated water with an increased TOC value to a use point.

The objects, features and advantages of the present application, described above and other, will become apparent from the detailed description set out below with reference to the accompanying drawings illustrating the present application.

### BRIEF DESCRIPTION OF DRAWINGS

FIG. 1 is a schematic diagram showing an example of a urea treatment apparatus.

FIGS. 2 (a) to 2(c) are a schematic diagram showing another example of a urea treatment apparatus, respectively.

FIG. 3 is a schematic diagram showing an embodiment of Examples 1 to 3 and Comparative Example 3.

FIG. 4 is a schematic diagram showing an embodiment of Comparative Examples 1 and 2.

FIG. 5 is a diagram showing an example of a pure water production system.

### DESCRIPTION OF EMBODIMENTS

The inventor has studied to solve the above problems and has made the following findings.

This is a finding that the urea treatment process, in which hypobromite ions are generated to decompose urea in a water to be treated water to obtain a treated water, is installed at two locations, and if urea tends to leak out in the first process, an additional urea decomposition agent (chlorine-based oxidation agent or acid) is injected in the second process to remove the urea, thereby ensuring that a treated water which the urea has been removed is always supplied at the optimum agent amount.

Hereinafter, the present invention will be described first with respect to a urea treatment method, and then a urea treatment apparatus capable of performing the treatment method will be described.

The urea treatment method of the present invention relates to a urea treatment method for treating urea in a water to be treated.

This urea treatment method has the following two treatment processes.
a first treatment process: a process of treating the urea by adding a bromide salt and a chlorine-based oxidation agent as a urea decomposition agent to the water to be treated containing urea.
a second treatment process: a process of treating a residual urea in a first treated water by adding at least one of a chlorine-based oxidation agent or a mineral acid as a urea decomposition agent to the first treated water obtained in the first treatment step

In the present invention, it is important to perform two treatment processes, and the two treatment processes may or may not be continuous. In addition, between the two treatment processes, there may also be a filtration process for the treated water, e.g. by a two-layer sand filter (multimedia filter: MMF), as described below, as long as no hypobromous acid consuming equipment (such as an activated carbon tower) is installed.

In the first treatment process, the urea decomposition agent (hereinafter, simply referred to as an “agent”) which generates hypobromous acid is added to the water to be treated at a preceding stage thereof.

As the water to be treated, a water containing urea can be used as appropriate, and a raw water for producing pure water such as an industrial water, a city water, a well water, and the like can be used as appropriate.

Urea is contained in the water to be treated, for example, about 2 to 500 μg/L.

The bromide salt and the chlorine-based oxidation agent are added as agents to generate hypobromous acid.

It is preferred that the bromide salt be water-soluble, e.g., sodium bromide (NaBr) is used.

As the chlorine-based oxidation agent, for example, hypochlorite, particularly sodium hypochlorite (NaClO) is used.

When the above agent is added to the water to be treated containing urea, the urea in the treated water is removed by a urea decomposition reaction in which the urea is selectively oxidised to obtain a first treated water.

This urea decomposition reaction is based on the following reaction.

NaBr+NaClO→NaBrO+NaCl

CO(NH₂)₂+3NaBrO→3NaBr+N₂+2H₂O+CO₂

The first treatment process can be performed by adjusting the water to be treated to normal temperature (e.g. about 20° C.), normal pressure (e.g. about 1 atm) and about pH 7, and allowing it to react for about 0.5 to 24 hours.

The amount of the bromide salt and the chlorine-based oxidation agent to be added is appropriately set according to the concentration of the urea in the water to be treated, and is not particularly limited, but is preferably added so that the concentration of the urea in the first treated water becomes 1 μg/L or less, and is usually about 1 to 5 mg/L of the bromide salt and about 1 to 10 mg/L of the chlorine-based oxidation agent.

As a method of adding the bromide salt and the chlorine-based oxidation agent, there is no particular limitation as long as it is in a form in which the generation of hypobromous acid ions is promoted, and a method in which each of an injection piping is installed in a water supply piping of the water to be treated and added them, a method in which a mixer such as a line mixer or a mixing reaction tank is used in combination, and the like, can be used.

Subsequently, the second treatment step, at the preceding stage, adding a chlorine-based oxidation agent or a mineral acid as an agent to the first treated water obtained in the first treatment step.

The chlorine-based oxidation agent and the mineral acid may be added at least one, it may be added both either.

As in the first treatment process, for example, hypochlorite, in particular sodium hypochlorite (NaClO), is used as a chlorine-based oxidation agent.

As the acid, for example, hydrochloric acid (HCl), nitric acid (HNO₃), phosphoric acid (H₃PO₄), and sulfuric acid (H₂SO₄) are used.

When for example, sodium hypochlorite (NaClO) is added to the first treated water as, the chlorine-based oxidation agent as in the first treatment process, a residual urea in the first treated water is removed by the same reaction as in the first treatment process, and a second treated water is obtained.

In addition, when HCl is added as the mineral acid, or when the chlorine-based oxidation agent and the mineral acid are added to the first treated water, the residual urea in the first treated water is removed by the same reaction as in the first treatment process only by changing pH in the first treated water, thereby obtaining a second treated water.

The second treated water is obtained by adding the chlorine-based oxidation agent and/or the mineral acid as the urea decomposition agent to the first treated water.

The second treatment process is performed by adding the chlorine-based oxidation agent and/or the mineral acid to the first treated water adjusted to normal temperature (e.g., about 20° C.) and normal pressure (e.g., about 1 atom) When the chlorine-based oxidation agent is added to the first treated water in the second treatment process, the chlorine-based oxidation agent is added so that the free residual chlorine level is preferably 1 to 10 mg/L.

In addition, in the second treatment process, when the mineral acid is added to the first treated water to adjust pH, it is preferable to set under the conditions of pH4 to 6.

When pH of the water to be treated is less than 4, there is an adverse effect that the hypobromite ion is gasified due to the addition of the above-described agent.

On the contrary, if the pH of the water to be treated exceeds 10, the treatment capacity of urea is improved, but it is not preferable because the salt loading is increased, and the above range is set.

In addition, when the chlorine-based oxidation agent and the mineral acid are used in combination in the second treatment process, it is preferable to add the chlorine-based oxidation agent and the mineral acid in such a manner that the amount of the chlorine-based oxidation agent and the mineral acid added is in the range described above, respectively.

In other words, it is preferable to add the chlorine-based oxidation agent so that the free residual chlorine level becomes 1 to 10 mg/L, and to add the mineral acid so as to be under the conditions of pH4 to 6

As a method of adding the chlorine-based oxidation agent and/or the acid, as in the first treatment process, a method in which each of an injection piping is installed in a water supply piping of the water to be treated and added them, a method in which a mixer such as a line mixer or a mixing reaction tank is used in combination, and the like, can be used.

In the urea treatment method of the present invention, it is preferable that a treatment time of the second treatment process is shorter than a treatment time of the first treatment process.

By shortening the treatment time of the second treatment process than the treatment time of the first treatment process, it is possible to supply the treated water from which the urea has been removed quickly.

Specifically, it is preferable to set the treatment time of the first treatment process: the treatment time of the second processing step processing step to 2:1 to 60:1.

In addition, in the urea treatment method of the present invention, it is preferable to control an amount of the agent added in the first treatment process and/or the second treatment process by monitoring a TOC or a urea concentration in the treated water.

Specifically, it is preferable to have a measurement process for measuring a TOC or a urea concentration in the second treated water obtained in the second treatment process, and an addition amount control process for controlling the addition amount of the urea decomposition agent in the first treatment process and/or the second treatment process according to the TOC or the urea concentration in the second treated water.

In this case, at least a process of measuring and monitoring the TOC concentration or the urea concentration in the second treated water at a rear stage of the second treatment process, for example, a TOC meter or a urea meter (a measuring apparatus) is installed at a rear stage of the second treatment process and a change in the TOC concentration or the urea concentration in the treated water is measured and monitored whereby the Addition amount of the agent in the second treatment process and the addition amount of the agent in the first treatment process can be controlled according to the TOC or the urea concentration in the second treated water.

When the process for monitoring changes in the TOC concentration or the urea concentration in the second treated water by the installation of the TOC meter or the urea meter is provided, as mentioned above, it is necessary to provide it at least a rear stage of the second treatment process, but it is preferable to provide it not only a rear stage of the second treatment process but also a rear stage of the first treatment process, because a leakage of urea can be detected quickly, and the agent can be added rapidly in a filtration apparatus or a filtration water tank (the facility for carrying out the second treatment process).

Not only the residual urea in the treated water but also the agent that produces hypobromous acid becomes a load to the pure water production system, so it is better if the agent input is small.

According to the invention for the present embodiment, since the urea concentration in the treated water is quantified to determine the necessity of the urea treatment and an appropriate amount of the agent can be charged when the treatment is necessary, it is possible to reduce the load on the pure water production system while suppressing the urea leakage from the reaction tank.

In addition, since the treatment time of the second treatment process can be set short, the control of exit management is easy to follow.

The control of exit management in the second treatment process is, for example, as follows:
(1) An increasing tendency (change/slope with time) of the TOC concentration or the urea concentration is detected, and the data about the increasing tendency of the TOC concentration or the urea concentration is entered into the learning algorithm provided in the machine learning apparatus.
(2) Based on the input data, the learning algorithm judges machine-learning-like “whether it is necessary to add the agent in order to make it not exceed a predetermined concentration”, and the machine learning apparatus outputs the data which shows “whether it is necessary to add the agent.”
(3) When it is judged that it is necessary to add the agent based on a machine-learning-like judgment, an addition amount of the agent is calculated, and the machine learning apparatus outputs data indicating the” addition amount of the agent” in addition to data indicating “whether it is necessary to add the agent”.

As described above, in the second treatment process, the addition amount of the agent can be controlled prior to reaching a control level of the TOC concentration or the urea concentration.

Further, it is preferable to provide a reduction treatment process at a rear stage of the second treatment step in order to reduct a residual oxidation agent component in the treated water.

It is preferable that the reduction treatment process is provided either at a preceding stage of or at a rear stage of a process of monitoring the TOC concentration or the urea concentration in the treated water, but is preferably provided at a preceding stage of the process of monitoring the TOC concentration or the urea concentration in the treated water from the viewpoint of the accuracy of detecting the TOC concentration or the urea concentration.

As the reducing agent used here, hydrogen peroxide or the like can be used.

Hereinafter, an example of a urea treatment apparatus for carrying out the urea treatment method of the present invention will be described with reference to the accompanying drawings.

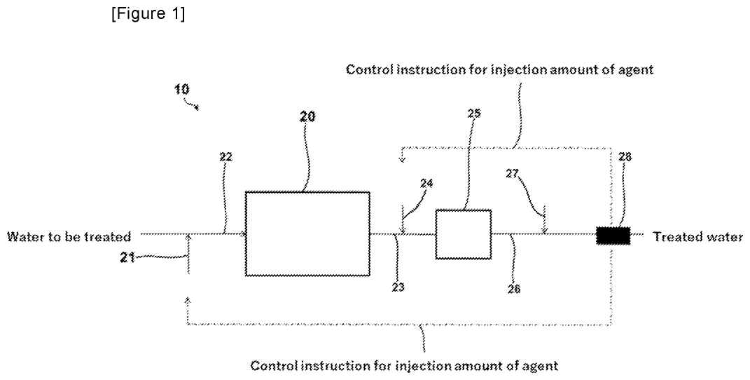

Note that, in FIG. 1 and the like, a urea treatment apparatus in the case where the urea treatment method according to the present invention is implemented in a series of systems is described, but the present invention is not limited thereto, and the urea treatment method according to the present invention may be implemented in a plurality of series of urea treatment apparatuses (systems).

The treatment apparatus 10 shown in FIG. 1 has two reaction tanks arranged in series.

An upstream reaction tank (a first reaction tank 20) and a downstream reaction tank (a second reaction tank 25) are connected by a second piping 23.

A first piping (a raw water supply piping) 22 for supplying water to be treated to the first reaction tank 20 is connected to an inlet of the first reaction tank 20, and a first addition means 21 for adding the bromide salt and the chlorine-based oxidation agent to the water to be treated is connected to the first piping 22

The first addition means 21 may be configured to add a mixture of the bromide salt and the chlorine-based oxidation agent to the water to be treated, or may be configured to add the bromide salt and the chlorine oxidation agent to the water to be treated, respectively.

Examples of the bromide salt include sodium bromide (NaBr), and examples of the chlorine-based oxidation agent include sodium hypochlorite (NaClO)

The first reaction tank 20 and the second reaction tank 25 are connected by the 23, the second piping 23 supplies the treated water treated in the first reaction tank to the second reaction tank 25.

The second piping 23 is connected to a second addition means 24 for adding at least one of the chlorine-based oxidation agent or the mineral acid.

The second reaction tank 25 is connected to a third piping 26 that drains the treated water.

The treated water to which the bromide salt and the chlorine-based oxidation agent are added by the first adding means 21 is supplied from the first piping 22 to the first reaction tank 20, and the urea in the water to be treated is treated in the first reaction tank 20 The resulting treated water is discharged from the first reaction tank via the second piping 23.

On its way of being supplied to the second reaction tank 25, at least one of the chlorine-based oxidation agent or the mineral acid is added from the second addition means 24 to the treated water discharged from the first reaction tank 20 via the second piping 23.

In the second reaction tank 25, the residual urea in the treated water treated in the first reaction tank 20 is treated, and the treated water is discharged from the second reaction tank 25 via the third piping 26.

In addition, each of the reaction tanks may be provided with a stirring mechanism (not shown in figures) as appropriate.

The stirring mechanism comprises a stirring apparatus, a submerged pump or an aeration apparatus.

A TOC meter or a urea meter 28 for monitoring the TOC concentration or the urea concentration in the treated water is provided at a rear stage of the second reaction tank 25, and the addition means 21 of the first reaction tank and/or the addition means 24 of the second reaction tank are controlled according to the TOC concentration or the urea concentration (see a dash-dotted line in FIG. 1), and the amount of the agent added can be controlled.

Further, a reducing agent for reducing the oxidation agent component contained in the treated water, for example, an addition means 27 of hydrogen peroxide is provided at a rear stage of the second reaction tank 25.

As the reducing agent, hydrogen peroxide, sodium sulfite, or the like can be used.

Hydrogen peroxide is preferred because it can reduce the oxidation agent component without increasing an ion load to a subsequent facility.

The addition means 27 of the reducing agent may be arranged either at a preceding stage of or at a rear stage of the TOC meter or the urea meter 28, but is preferably arranged at a preceding stage of the TOC meter or the urea meter from the viewpoint of detecting accuracy of the TOC concentration or the urea concentration, and preventing degradation of the pretreatment apparatus prior to detecting at the TOC concentration or the urea concentration.

It is preferable that a residence time of the water to be treated in the second reaction tank 25 (the treatment time in the second treatment step) is shorter than a residence time of the water to be treated in the first reaction tank 20 (the treatment time in the first treatment step)

Adjustment of the residence time of the water to be treated in the reaction tank can be adjusted, for example, by making the capacity of the second reaction tank 25 smaller than that of the first reaction tank 20. In this case, it is preferable to set the capacity of the first reaction tank 20: the capacity of the second reaction tank 25 to 2:1 to 60:1.

Note that the second reaction tank 25 may utilize an existing filtration apparatus or a raw water tank, and both of them, and a plug flow may be used as long as the urea decomposition reaction proceeds.

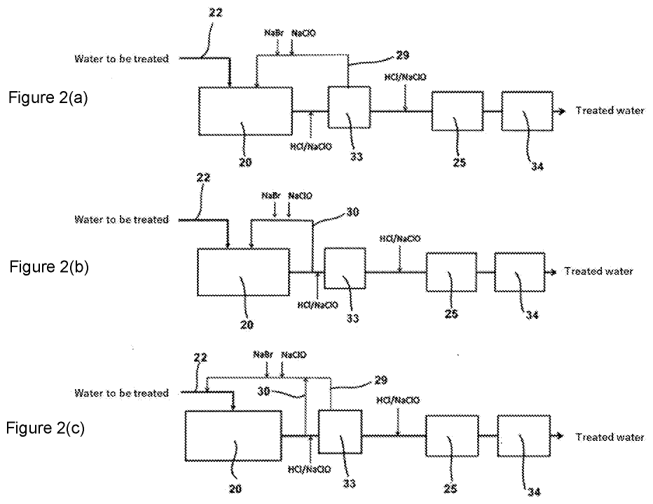

As shown in FIGS. 2 (a) to (c), a double-layered sand filtration apparatus (multimedia filtration apparatus: MMF) may be installed at a rear stage of the first reaction tank 20 for filtering a turbid component.

In the MMF 33, a backwashing treatment and a rinsing treatment are periodically performed.

In a backwash water used in the backwash treatment or a rinse water used in the rinse treatment, a water having good water quality after the second reaction tank 25 can be used as a supply source (not shown in figures).

Among a water discharged from the MMF 33 by the rinse treatment (a rinse drainage), a water quality is judged by a water quality meter not shown in figures, and a water with relatively good quality (a rinse drainage) is returned to the first reaction tank 20 via a return piping (a fourth piping) 29 as a rinse return water, as shown in FIG. 2(a), and a water with poor quality is discarded from a piping not shown in figures.

The flow rate of the rinse return water is obtained by a flow meter not shown in figures.

To the rinse return water flowing through the fourth piping 29, agents such as the bromide salt and the chlorine-based oxidation agent, for example, sodium bromide (NaBr) and sodium hypochlorite (NaClO), may be added.

At this time, for example, a line mixer (not shown in sures) can be used for mixing the rinse return water containing the agent.

The addition amount of the agent (an injection amount of the agent) can be determined by installing a residual salt meter (not shown in figures) in the fourth piping 29.

That is, if the treated water supplied from the piping 22 to the first reaction tank 20 does not flow from the piping 22, to control the chemical injection amount in accordance with the water amount of only rinse return water, also if it flows from the piping 22, it is possible to control the chemical injection amount in accordance with the flow rate from the piping 22 in addition to the rinse return water.

Further, as shown in FIG. 2 (a), the agent such as the mineral acid and/or hypochlorous acid, e.g., hydrochloric acid (HCl) and/or sodium hypochlorite (NaClO), may be added in the preceding stage of the MMF 33, and may be added both in the preceding stage of the MMF 33 and in the preceding stage of the second reactive tank 25.

Also, as shown in FIG. 2 (b), a portion of the pipe that delivers from the first reaction tank 20 to the MMF 33 may be branched to form the return piping to the first reaction tank 20 (a fifth piping 30).

There is usually more than one MMF 33 installed at the rear of the first reaction tank 20, taking into account breakdowns, maintenance, etc., and there may be the MMF 33s that are not in operation.

In this case, of the piping branching from the first reaction tank 20 to MMF 33 to connect to the first reaction tank 20, the piping branching from the piping that feeds the MMF 33 that is not operated from the first reaction tank 20 can be the return piping to the first reaction tank 20 (the fifth piping 30).

The agent can also be added to this fifth piping.

At this time, a mixing of the rinse water containing the agent can be mixed using, for example, the line mixer (not shown in figures).

The injection amount of the agent may be determined by placing the residual salt meter not shown in figures in the fifth piping.

In other words, it is possible to control the injection amount of the agent in accordance with the amount of water such as the rinse return water.

By providing such the fifth piping 30, even when no rinse water is generated by backwashing treatment by the MMF 33, the agent can be added.

Further, as shown in FIG. 2 (b), the agent such as the mineral acid and/or hypochlorous acid, e.g., hydrochloric acid (HCl) and/or sodium hypochlorite (NaClO), may be added in the preceding stage of the MMF 33, and may be added in both the preceding stage of the MMF 33 and in the preceding stage of the second reactive tank 25.

Further, as shown in FIG. 2 (c), by adding the agent to the above-described fourth piping 29, or the fifth piping 30, further by merging with the first piping 22 for delivering the water to be treated, it is possible to be surely chemically injected when the water to be treated flows into the first reaction tank 20.

The injection amount of the agent can be determined by installing a residual salt meter (not shown in figures) in the fourth piping 29 or the fifth piping 30.

That is to say, it is possible to control the injection of the agent according to the water amount such as the rinse return water.

Further, as shown in FIG. 2 (b), the agent such as the mineral acid and/or hypochlorous acid, e.g., hydrochloric acid (HCl) and/or sodium hypochlorite (NaClO), may be added in the preceding stage of the MMF 33, and may be added in both the preceding stage of the MMF 33 and in the preceding stage of the second reaction tank 25.

Further, as shown in FIGS. 2 (a) to (c), in the rear stage of the second reaction tank 25, as a means for removing the oxidation agent component contained in the second treated water, separate from the addition means of the reducing agent for reducing the aforementioned oxidation agent component, it is preferable to provide an activated carbon tower 34.

By providing the activated carbon tower 34, deterioration of the downstream RO film can be prevented or the like.

In the case where the MMF 33 described above is provided, the embodiment in which part of the rinse water is used as the return rinse water has been described, but in FIGS. 2(a) to 2(c), the urea treatment method according to the present invention is performed in a single system, so a timing of the start of rinsing and a timing of the raw water supply must be aligned.

In this case, it is preferable that water is stored in the reaction tank and not flowed to the rear stage until the rinsing is completed (until the injection of the agent is completed).

When the urea treatment method according to the present invention is performed in a plurality of series of systems, it is not necessary to adjust the timing of the start of rinsing and the timing of the raw water supply because the rinse water obtained in the other series can be used.

In the treatment equipment of the present invention, the timing of the addition of the agent (the injection of the agent) to the first reaction tank can also be coupled to an automatic valve opening and closing (not shown in figures) provided in the raw water supply piping (the first piping) 22.

For example, when the raw water flows in (when a pump for the raw water inflow becomes ON), an injection of the bromide salt and the chlorine-based oxidation agent can be started, and the injection of bromide salt and the chlorine-based oxidizing agent can be stopped when raw water inflow stops (when the pump for raw water inflow becomes OFF).

The treatment apparatus and the treatment methods of the present invention described above are suitable, for example, as a pretreatment method and a pretreatment apparatus in a pure water production system used to produce pure water from a raw water such as a tap water, a ground water and an industrial water, and can also be applied to a treatment apparatus and a treatment system for removing a TOC from a wastewater recovery water, used for the purpose of reducing water consumption, etc.

### (Pure Water Production System)

The treatment apparatus according to the present invention can be used as a pretreatment apparatus for pure water production.

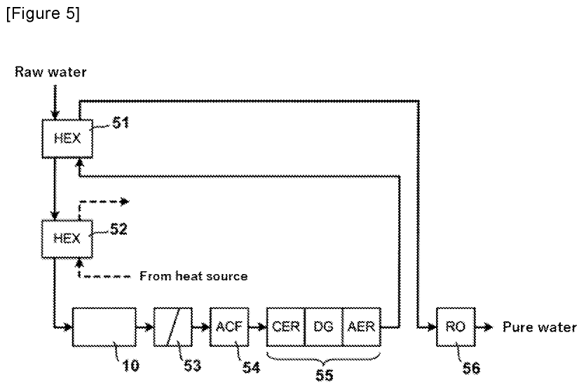

FIG. 5 illustrates a pure water production system incorporating a urea treatment apparatus according to the present invention.

The pure water production system, shown in the figure, produces a primary pure water from a raw water, and comprises a heat exchanger (HEX) 51,52 in a series of two steps supplied with a raw water, a urea treatment apparatus 10 supplied with the raw water as the water to be treated discharged from the heat exchanger 52 in the downstream, a filtration apparatus 53, an activated carbon apparatus (ACF) 54, an ion-exchange apparatus 55, and a reverse osmosis membrane apparatus (RO) 56.

As the urea treatment apparatus 10, for example, the urea treatment apparatus 10 shown in FIG. 1 is used.

The filtration apparatus 53, the activated carbon apparatus (ACF) 54, and the ion exchange apparatus 55 are connected to an outlet of the urea treatment apparatus 10 in this order.

The ion-exchange apparatus 55 includes a cation exchange resin tower (CER), a decarboxylation tower (DG), and an anion exchange resin tower (AER) arranged from an inlet end thereof.

A water discharged from the ion exchange apparatus 55 is supplied to the upstream heat exchanger 51 to be used as a heat source to elevate the raw water, and subsequently supplied to the reverse osmosis membrane apparatus 56.

The primary pure water is discharged from the reverse osmosis membrane apparatus 56

After all, in the pure water production system shown in FIG. 5, the urea treatment apparatus 10 is provided as the pretreatment apparatus for a pure water production system comprising the filtration apparatus 53, the activated carbon apparatus 54, the ion-exchange apparatus 55, and the reverse osmosis membrane apparatus 56

In addition, in the pure water production system shown in FIG. 5, it is possible to use the filtration apparatus 53 connected to a rear stage of the urea treatment apparatus 10 as the second reaction tank 25.

Needless to say, the configuration of the pure water production system provided at the rear stage of the urea treatment apparatus 10 is not limited to that shown in FIG. 5.

Hereinafter, the heat exchanger 51 and 52 will be described.

The decomposition reaction of urea by hypobromous acid proceeds faster when the reaction temperature is increased.

Therefore, the heat exchanger 51 and 52 is provided to warm the water to be treated.

For the heat exchanger 51 on the upstream side, the water discharged from the ion exchange apparatus 55 is supplied as a heat source.

The water discharged from the ion exchange apparatus 55 is a water obtained by passing the treated water from the urea treatment apparatus 10 through the filtration apparatus 53, the activated carbon apparatus 54 and the ion exchange apparatus 55, and the temperature is increased by being heated at a preceding stage of the urea treatment apparatus 10, but it is difficult to raise a temperature of the water to be treated supplied to the urea treatment apparatus 10 to a predetermined temperature by this alone.

Then, the heat exchanger 52 on the downstream side is supplied with heat medium from a heat source of more higher temperature, by which the temperature of the raw water supplied as a water to be treated for urea treatment apparatus 10 is raised to a predetermined temperature.

In the pure water production system shown in FIG. 5, the water discharged from the ion exchange apparatus 55 and before being supplied to the reverse osmosis membrane apparatus 56 is supplied as a heat source to the heat exchanger 51, however, which part of the pure water production system that is provided at the rear stage of the urea treatment apparatus 10, the water flowing through is supplied to the heat exchanger 51 can be determined accordingly according to the configuration of the pure water production system, etc.

For example, when an activated carbon apparatus is provided in the pure water production system, if the water flowing through the rear stage than the activated carbon apparatus is supplied to the heat exchanger 51, a water supplied to the activated carbon apparatus is in a warmed state, so that an activity of a biological activated carbon can be increased.

Conversely, when a water flowing through the preceding stage of the activated carbon apparatus is constituted to supply the heat exchanger 51, a water temperature at an entrance of the activated carbon apparatus is lowered, so it is possible to increase an adsorption amount in the activated carbon apparatus.

When an agglutination tank is provided in the pure water production system, by supplying a warmed water discharged from the urea treatment apparatus 10 to the agglutination tank, it is possible to suppress an agglutination failure due to low water temperature.

In a pure water production system that produces pure water from raw water, a tank that temporarily stores the raw water is generally placed at the inlet of the system to smooth the supply of raw water to the pure water production system.

In the pure water production system shown in FIG. 5, the reaction tank 20 in the treatment apparatus 10 also functions as a tank for temporarily storing raw water, eliminating the need for a separate tank for temporarily storing raw water.

### EXAMPLES

The present invention is explained in more detail below by means of Examples and Comparative Examples.

### Example 1

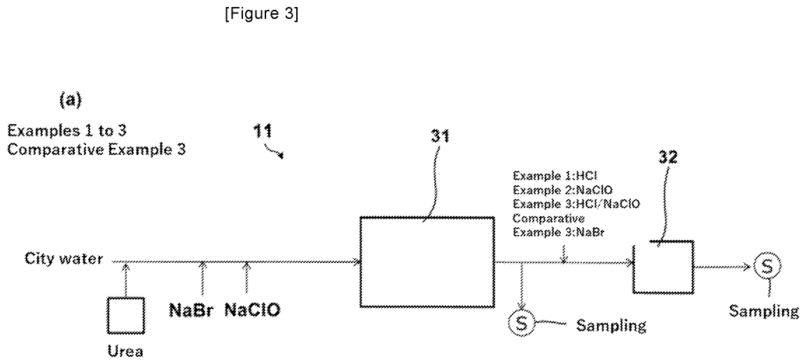

A treatment apparatus 11 shown in FIG. 3 was assembled. Urea was added to Sagamihara city water and prepared to a concentration of 50 μg/L, which was used as a water to be treated.

The water to be treated was adjusted to pH 7 and a water temperature of 20° C. and supplied at a flow rate of 75 L/hr to a first reaction tank 20 having a volume of 300 L.

At the preceding stage of the first reaction tank 31, 2 mg/L of sodium bromide and 2.2 mg/L of sodium hypochlorite were added to perform urea decomposition for 4 hours.

The treated water was supplied to a second reaction tank 32 having a volume of 75 L, and at a stage preceding the second reaction tank 32, hydrochloric acid was added to adjust the water to a pH6 and performed to urea decomposition for 1 hours.

100 ml of an outlet water from the first reaction tank 31 was taken in portions, hydrogen peroxide was added to the outlet water until there was no more oxidant, and the urea concentration in the treated water was analyzed, which was 3.8 μg/L.

Similarly, 100 ml of an outlet water from the second reaction tank 32 was was taken in portions, and hydrogen peroxide was added to the outlet water, and the urea concentration in the treated water at this time was <1 μg/L.

The urea concentrations in the water to be treated and the treated water were determined by LC-MS analysis.

### Example 2

The same tests as in Example 1 were conducted except that sodium hypochlorite was added instead of hydrochloric acid at the preceding stage of the second reaction tank 31.

For the addition of sodium hypochlorite at the preceding stage of the second reaction tank 32, 4 mg/L of sodium hypochlorite was added to achieve a residual chlorine concentration of 4.4 mg/L in the treated water.

The urea concentration in the treated water discharged from the first reaction tank 31 was 3.8 μg/L. The urea concentration in the treated water discharged from the second reaction tank 32 was 1.4 μg/L.

### Example 3

The same tests as in Example 1 were conducted except that both hydrochloric acid and sodium hypochlorite were added at the preceding stage of the second reaction tank 32.

For the addition of hydrochloric acid and sodium hypochlorite at the preceding stage of the second reaction tank 32, hydrochloric acid was added and adjusted to pH 6, and then 4 mg/L of sodium hypochlorite was added to achieve a residual chlorine concentration of 4.4 mg/L in the treated water.

The urea concentration in the treated water discharged from the first reaction tank 31 was 3.8 μg/L. The urea concentration in the treated water discharged from the second reaction tank 32 was <1 μg/L.

### Comparative Example 1

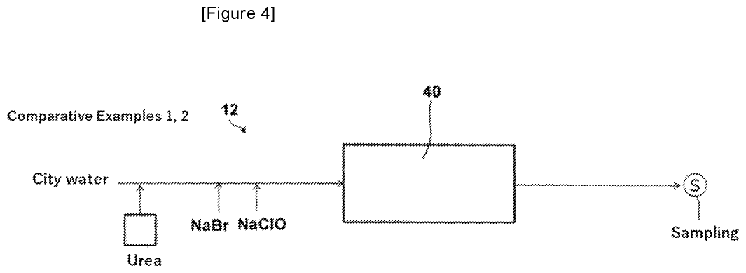

A treatment apparatus 12 shown in FIG. 4 was assembled. Urea was added to Sagamihara city water and prepared to a concentration of 50 μg/L, which was used as a water to be treated.

The water to be treated was adjusted to pH 7 and a water temperature of 20° C. and supplied at a flow rate of 75 L/hr to a reaction tank 40 having a volume of 375 L.

At the preceding stage of the reaction tank 40, 2 mg/L of sodium bromide and 2.2 mg/L of sodium hypochlorite were added to perform urea decomposition for 5 hours.

100 ml of an outlet water from the reaction tank 40 was taken in portions, hydrogen peroxide was added to the outlet water until there was no more oxidant, and the urea concentration in the treated water was analyzed, which was 2.0 μg/L.

### Comparative Example 2

The same tests as in Example 1 were conducted except that after 4 hours from the urea decomposition reaction, an additional 4 mg/L of sodium hypochlorite was added to the reaction tank 40 to achieve a residual chlorine concentration of 4.4 mg/L.

After 5 hours form the start of the urea decomposition reaction (after 1 hour form the addition of sodium hypochlorite), 100 ml of an outlet water from the reaction tank 40 was taken in portions, hydrogen peroxide was added to the outlet water until there was no more oxidant, and the urea concentration in the treated water was analyzed, which was 2.0 μg/L.

### Comparative Example 3

The same tests as in Example 1 were conducted except that 2 mg/L of sodium bromide was added instead of hydrochloric acid at the preceding stage of the second reaction tank 30.

The urea concentration in the treated water discharged from the first reaction tank 20 was 3.8 μg/L. The urea concentration in the treated water discharged from the second reaction tank 30 was 3.8 μg/L.

The results of the above Examples 1-3 and Comparative Examples 1-3 are summarized in Table 1.

TABLE 1

| | Example | Example | Example | Comparative | Comparative | Comparative |
|---|---|---|---|---|---|---|
| | 1 | 2 | 3 | Example 1 | Example 2 | Example 3 |
| Urea concentration in | 3.8 | 3.8 | 3.8 | 2 | 2 | 3.8 |
| treated water in the first | | | | | | |
| reaction tank (μg/L) | | | | | | |
| Urea concentration in | <1 | 1.4 | <1 | | | 3.8 |
| treated water in the | | | | | | |
| second reaction tank(μ | | | | | | |

From these results, it was confirmed that in the urea decomposition process by adding a bromide salt and a chlorine-based oxidation agent, the urea decomposition reaction is carried out in two steps, and chlorine-based oxidation agent and/or acid are added in the second step to adjust the reaction pH and residual chlorine concentration, thereby ensuring stable urea decomposition treatment.

Although some preferred embodiments of the invention have been shown in detail and described, it is to be understood that various changes and modifications are possible without departing from the intent or scope of the appended claims.

### EXPLANATION OF CODES

10 Urea treatment apparatus of the present invention.
11 Urea treatment apparatus of Examples 1-3 and Comparative Example 3
12 Urea treatment apparatus of Comparative Examples 1 and 2
20 First reaction tank.
21 First addition means
22 First piping
23 Second piping
24 Second addition means
25 Second reaction tank
26 Third piping
27 Means of adding reducing agents.
28 TOC meter or urea meter
29 Fourth piping
30 Fifth piping
31 First reaction tank
32 Second reaction tank
33 MMF
34 Activated carbon tower
35 Reaction tank
51, 52 Heat exchanger
53 Filtration apparatus
54 Activated carbon apparatus
55 Ion exchange apparatus
56 Reverse osmosis membrane apparatus

1. A urea treatment apparatus for treating urea in a water to be treated, comprising:
a first reaction tank in which urea in the water to be treated is treated;
a first addition means connected to the first reaction tank or to a first piping connected to the first reaction tank and supplying the water to be treated to the first reaction tank, for adding a bromide salt and a chlorine-based oxidation agent to the water to be treated;
a second reaction tank in which a residual urea in a first treated water treated by the first reaction tank is treated
a second addition means connected to the second reaction tank or to a second piping connected to the second reaction tank and supplying the first treated water to the second reaction tank, for adding a chlorine-based oxidation agent or a mineral acid to the first treated water.

2. The urea treatment apparatus according to claim 1, wherein a residence time of the first treated water in the second reaction tank is shorter than a residence time of the water to be treated in the first reaction tank.

3. The urea treatment apparatus according to claim 1 or 2, comprising:
a measuring apparatus which is installed at the rear of the second reaction tank to measure a TOC or urea concentration in the second treated water treated in the second reaction tank; and
a means controlling an amount of addition from the first addition means and/or the second addition means according to the TOC or urea concentration in the second treated water.

4. The urea treatment apparatus according to any one of claims 1 to 3, comprising a means for adding a reducing agent, which is installed at the rear of the second reaction tank and reduces the oxidant component in the second treated water.

5. A pure water production system comprising the urea treatment apparatus according to any one of claims 1 to 4, an ion exchange apparatus which is installed at the rear of the urea treatment apparatus and supplied with a water treated by the urea treatment apparatus, and a reverse osmosis membrane apparatus which is installed at the rear of the ion exchange apparatus and supplied with a water treated by the ion exchange apparatus.

6. A urea treatment method for treating urea in a water to be treated, comprising:
a first treatment process in which a bromide salt and a chlorine-based oxidation agent are added to the water to be treated as a urea decomposition agent, and
a second treatment process in which at least one of a chlorine-based oxidation agent or a mineral acid is added to the first treated water obtained in the first treatment process to treat a urea remaining in the first treated water.

7. The urea treatment method according to claim 6, wherein a treatment time of the second treatment process is shorter than a treatment time of the first treatment process.

8. The urea treatment method according to claim 6 or 7, comprising:
a measurement process for measuring a TOC or urea concentration in the second treated water obtained in the second treatment process; and
an addition amount control process for controlling an amount of the urea decomposition agent added in the first treatment process and/or the second treatment process according to the TOC or urea concentration in the second treated water.

9. The urea treatment method according to any one of claims 6 to 8, comprising a reduction process to reduce an oxidant component in the second treated water.

10. A method for producing pure water, comprising the urea treatment method according to any one of claims 6 to 9, as a pre-treatment process.
